(19) United States
(12) Patent Application Publication
(10) Pub. No.: US 2010/0004958 A1
(43) Pub. Date: Jan. 7, 2010

(54) SYSTEM AND METHOD FOR INTELLIGENTLY REROUTING STRANDED TRAVELERS

(75) Inventors: Bryan A. Ackermann, Fairfax, VA (US); Michael L. Fleishman, Oxford, CT (US); Kevin C. Mcconnell, Austin, TX (US); Robert G. Oesterlin, Rochester, MN (US)

Correspondence Address: Locke Lord Bissell & Liddell LLP;Attn: IP Docketing, Three World Financial Center, New York, NY, 10281-2101, US

(73) Assignee: INTERNATIONAL BUSINESS MACHINES CORPORATION, Armonk, NY (US)

(21) Appl. No.: 12/166,855

(22) Filed: Jul. 2, 2008

(51) Int. Cl. G06Q 10/00

(52) U.S. Cl. 705/5

(57) ABSTRACT

A method is disclosed to intelligently reroute stranded travelers. The method includes receiving in a computer, a message from a customer containing preferences for travel services, including willingness to accept alternative travel services, and storing the preferences in a customer database. The method then includes receiving in the computer, a message from the customer containing a trip plan that includes at least one segment with a desired mode of transportation, a desired departure location, a desired time, and a desired destination, and storing the trip plan in the customer database. The method then includes receiving in the computer, a message from at least one travel service, including available scheduling for the at least one segment, and data for alternative times and modes of transportation, and storing the available scheduling and the data. The method then includes receiving in the computer, a message from the customer agreeing to the available scheduling for the at least one segment. The method then includes receiving in the computer, a message from the at least one travel service, that the agreed to scheduling for the at least one segment has become unavailable. The method then includes accessing the preferences and the data. The method then includes determining acceptable alternative times and modes of transportation from the data and the preferences for the at least one segment. The method then includes automatically scheduling one of the acceptable alternative times and modes of transportation for the at least one segment. And finally, the method includes sending a notification to the customer of the automatically scheduled alternative time and mode of transportation for the at least one segment.

### FIELD

The embodiments relate to travel services.

### BACKGROUND

Flights are cancelled every day because of weather, mechanical, or other problems. When cancellations happen, passengers have very limited information about their options for reaching their destination and often have no immediate way of acting on those options even if they had had them at their fingertips. Those options that are available are carrier or service provider specific, and do not incorporate statistical data (on time percentage, cancellation rates, current weather data, airport delays, etc.), which would provide passengers with better context to make informed decisions.

There are some known solutions to this problem. For example, the passenger may wait for the airline to inform him of his options and when he will be rebooked on another flight. Also, the passenger may call the airline's service desk to be rebooked on another flight. The passenger may also call a travel agency. In addition, the airline may automatically rebook the passenger on the next available flight, based on schedule.

However, there are several drawbacks to these known solutions, including that the passenger may not be exposed to all options that are available. Also, the passenger may be in the same position as every other passenger that is affected and must wait or contend with his “peers” once an option is provided. The passenger may also be put on hold for extended periods of time when he tries to call the airline or travel agency directly. Because these options are often very limited (i.e. only X number of open seats available on alternative flights), the passenger may find it difficult to get an alternative option (i.e. seat on a different flight). In addition, an alternative option may be available, but the passenger may not seek it out until he gets a “final” status report from the airline agent, by which time the alternative option(s) may no longer be available. The passenger may be given options by the airline/carrier/etc., which do not incorporate historical on-time and cancellation data, current weather data, and current flight operations/airport delay data, making it likely that the passenger may replace one cancelled flight with one that may also be cancelled or delayed.

### SUMMARY

A method is disclosed to intelligently reroute stranded travelers. The method includes receiving in a computer, a message from a customer containing preferences for travel services, including willingness to accept alternative travel services, and storing the preferences in a customer database. The method then includes receiving in the computer, a message from the customer containing a trip plan that includes at least one segment with a desired mode of transportation, a desired departure location, a desired time, and a desired destination, and storing the trip plan in the customer database. The method then includes receiving in the computer, a message from at least one travel service, including available scheduling for the at least one segment, and data for alternative times and modes of transportation, and storing the available scheduling and the data. The method then includes receiving in the computer, a message from the customer agreeing to the available scheduling for the at least one segment. The method then includes receiving in the computer, a message from the at least one travel service, that the agreed to scheduling for the at least one segment has become unavailable. The method then includes accessing the preferences and the data. The method then includes determining acceptable alternative times and modes of transportation from the data and the preferences for the at least one segment. The method then includes automatically scheduling one of the acceptable alternative times and modes of transportation for the at least one segment. And finally, the method includes sending a notification to the customer of the automatically scheduled alternative time and mode of transportation for the at least one segment.

This service to intelligently reroute stranded travelers (IRST) provides a customer of a missed connection or cancelled travel service, proactive, real-time options for reaching a destination. IRST is a public service that is a mobile application that a user can access from a wireless computing device. A user subscribes to the service and has all of his trips monitored by the service.

An IT services company can run the IRST computing system to provide this service. The service can charge a monthly fee or retain a percentage of the services sold through the system. The services company can also be partnered with an existing on-line travel agency in order to offer more verbose options in real-time for the passenger.

This service offers many advantages. For example, when a flight issue occurs, the system can intelligently inform and help the passenger reach his destination in the required time. Also, the system can be both “passive” and “active”: passive in that it provides notification of alternative travel options, and active in that it automatically books an alternative option based on account preferences. In addition, the service proactively researches travel options with the view that there will be issues with every trip.

### DESCRIPTION OF THE FIGURES

FIG. 1 is a functional block diagram of a computer system that performs intelligent rerouting of stranded travelers.

FIG. 2 is an example flow diagram of an example embodiment for the sequence of steps carried out by the program logic of FIG. 1.

### DISCUSSION OF EXAMPLE EMBODIMENTS

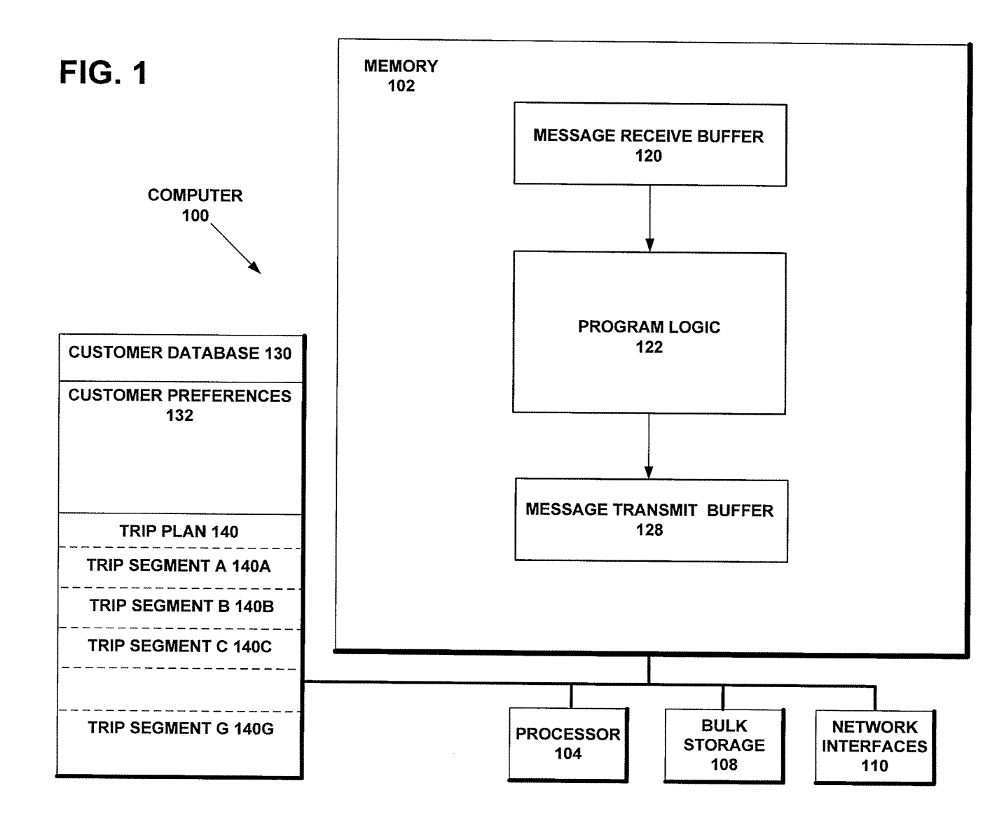

FIG. 1 is a functional block diagram of a computer system that performs intelligent rerouting of stranded travelers. A computer system 100 includes a memory 102, processor 104, bulk storage 108, network interfaces 110, and customer database 130. The memory 102 includes a message receive buffer 120, program logic 122, and message transmit buffer 128. The customer database 130 includes customer preferences 132 and a trip plan 140. The trip plan 140 includes a trip segment A 140A, trip segment B 140B, trip segment C 140C, etc.

The system and method intelligently reroutes stranded travelers. The method includes receiving in a computer 100, a message from a customer containing preferences 132 for travel services, including willingness to accept alternative travel services, and storing the preferences 132 in a customer database 130. The method then includes receiving in the computer 100, a message from the customer containing a trip plan 140 that includes at least one segment with a desired mode of transportation, a desired departure location, a desired time, and a desired destination, and storing the trip plan 140 in the customer database 130. The method then includes receiving in the computer 100, a message from at least one travel service, including available scheduling for the at least one segment, and data for alternative times and modes of transportation, and storing the available scheduling and the data. The method then includes receiving in the computer 100, a message from the customer agreeing to the available scheduling for the at least one segment. The method then includes receiving in the computer 100, a message from the at least one travel service, that the agreed to scheduling for the at least one segment has become unavailable. The method then includes accessing the preferences 132 and the data. The method then includes determining acceptable alternative times and modes of transportation from the data and the preferences 132 for the at least one segment. The method then includes automatically scheduling one of the acceptable alternative times and modes of transportation for the at least one segment. And finally, the method includes sending a notification to the customer of the automatically scheduled alternative time and mode of transportation for the at least one segment.

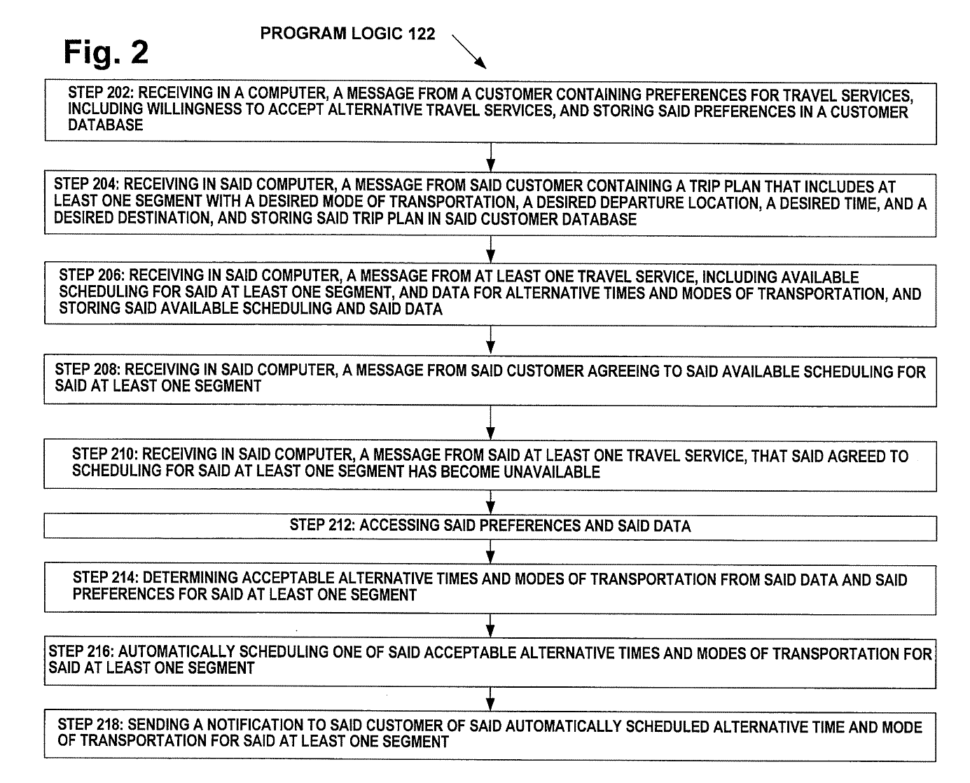

FIG. 2 is an example flow diagram of an example embodiment for the sequence of steps carried out by the program logic of FIG. 1.

Step 202 is receiving in a computer, a message from a customer containing preferences for travel services, including willingness to accept alternative travel services, and storing the preferences in a customer database. The customer may register with the service to intelligently reroute stranded travelers (IRST) by signing up on the IRST home page, and the customer may record his frequent traveler i.d. number in the system to be monitored. The customer may also define a profile detailing what alternative options he is willing to accept (i.e. flights on a different airline, later flights on the same airline, rental car, or train). In addition, the customer may have the option of having payment information (i.e. credit card information) saved in his profile for immediate booking of an alternative mode of travel.

Step 204 is receiving in the computer, a message from the customer containing a trip plan that includes at least one segment with a desired mode of transportation, a desired departure location, a desired time, and a desired destination, and storing the trip plan in the customer database.

Step 206 is receiving in the computer, a message from at least one travel service, including available scheduling for the at least one segment, and data for alternative times and modes of transportation, and storing the available scheduling and the data. This step inquires into whether the travel issue was a result of a mechanical problem, a missed their connection, or a weather problem.

Step 208 is receiving in the computer, a message from the customer agreeing to the available scheduling for the at least one segment. Once the customer books a trip using his frequent traveler i.d., the system starts the monitoring process. If the customer books a trip on a service that he has not registered with, he may need to contact the service and perform a manual trip registration. In addition, the system proactively builds a package of possible alternatives for each segment of the customer's travel. The system performs an hourly check to ensure that alternatives are still available to offer the customer in case of a travel issue.

Step 210 is receiving in the computer, a message from the at least one travel service, that the agreed to scheduling for the at least one segment has become unavailable. The system automatically monitors the travel services' status data feeds and when the system detects a travel issue, the system proactively starts communicating with the customer. In the event that the travel services do not update their data feeds, the customer can initiate this step by contacting IRST and indicating that there is a travel issue.

Step 212 is accessing the preferences and the data.

Step 214 is determining acceptable alternative times and modes of transportation from the data and the preferences for the at least one segment. This step inquires into whether the customer is likely to reach his destination on the current day, taking into account the past history of mechanical and weather issues. If travel is likely on the current day, IRST informs the customer that the travel service plans to move the customer to the next available service. IRST confirms the time and whether the customer wishes to take this next scheduled service.

However, if the primary mode of transportation is not available on the current day, the system offers the customer alternatives. If an alternative is selected, the system will arrange for ground transportation to move the customer to the new service terminal. For example, if flights are cancelled due to weather, the system may offer the customer options for a rental car, bus, train, private car, or taxi. In another example, if the last flight of the day is cancelled due to a mechanical issue or missed connection, private jet/plane options may be offered to the customer so he may reach his destination in the required time.

If the customer is at his home location, this step inquires into whether he wishes to cancel the trip, receive a refund, and return home.

Based on the customer preferences, IRST provides options to the customer and informs the customer that travel options are available for review.

IRST allows the customer to rebook through his defined interface in the customer database. If remaining on the same mode of transportation, IRST will show the customer alternate routes, times and alternate travel companies. If the customer is open to take alternate modes of transportation, IRST will provide the customer with alternate modes of transportation, routes and times and will rank the options. In ranking options, IRST will use current and historical data, including historical on-time percentages, historical flight delay times, current weather data and associated travel service operations impact, and other relevant data sources currently available across airlines. IRST may provide several views/options to help the customer make the best informed decision to rebook his travel. Some examples of these options include, ease of booking (e.g., auto-book on next available flight on existing carrier, no gate or airport change), cost (e.g., lowest incremental cost change, or cost change within a specified dollar amount), and time to destination (e.g., would arrive at destination within a specified delay time—within X hours).

If the system rebooks the customer on a travel service for the following day, the customer may need a place to stay for the night. The system offers hotel options and allows the customer to book through the IRST interface. If the airline is at fault, the system arranges for the airline to pay for the hotel. The system also arranges for transportation to and from the terminal.

In addition, IRST can show the customer an airport map to help him find required services. This feature may be enhanced with devices enabled with AGPS technology to show where the customer is in relationship to the map. For example, IRST may provide the customer with restaurant options, including information on where the restaurant is located, its operating times, a price comparison, food style, user reviews, etc. IRST may also provide automated meal vouchers based on the travel service rules and relationships.

The system shows the customer the airline policies on refunds and transfers in case of weather cancellations, mechanical issues, or missed connections. As appropriate, the system arranges for refunds for the customer.

Step 216 is automatically scheduling one of the acceptable alternative times and modes of transportation for the at least one segment.

Step 218 is sending a notification to the customer of the automatically scheduled alternative time and mode of transportation for the at least one segment.

In this manner, the method intelligently reroutes stranded travelers.

In one scenario, a traveler is sitting on the last flight out of Geneva Switzerland to Helsinki Finland. There is a mechanical problem that cancels the flight. After three hours of little to no information, the airline buses the traveler one-and-a-half hours north to a hotel. While waiting in the airport, the only restaurant in the airport closes, so there is no food or drink available to the traveler. In the morning, the traveler is returned to the airport and waits another eight hours for the plane to be repaired and finally reaches his destination twenty-four hours late. The traveler had a noon meeting on the following day. If the customer had been using IRST, then the service would have seen that there was a flight from Zurich to Helsinki leaving at 7 am the following day and booked the customer on that flight. Also, IRST could have booked the traveler in a hotel near the Zurich airport using a travel voucher from the airline. IRST could have also arranged ground transportation for the customer to the hotel and to the airport using a travel voucher from the airline. In addition, IRST could have informed the traveler where the airport services were to obtain a meal and drink prior to the restaurant closing. The traveler would have arrived in Helsinki by 10 am and made his noon meeting.

In another scenario, a traveler is flying from Seattle, Wash. to Cordova, Ak. via Anchorage. The flight is delayed to Anchorage and the traveler misses her connection. When the traveler arrives in Anchorage, she searches for the airline counter to obtain a seat on the next flight. After waiting in line for thirty minutes, she is told to go to a different counter. After waiting another thirty minutes, the traveler finds out that there are no seats left on the last fight to Cordova. The traveler has to wait another twenty-four hours for the next flight. If the traveler had been using IRST, the service would have detected that the traveler was not going to make her connection and would have automatically booked her on the last flight to Cordova.

Using the description provided herein, the embodiments may be implemented as a machine, process, or article of manufacture by using standard programming and/or engineering techniques to produce programming software, firmware, hardware or any combination thereof.

Any resulting program(s), having computer-readable program code, may be embodied on one or more computer-usable media such as resident memory devices, smart cards or other removable memory devices, or transmitting devices, thereby making a computer program product or article of manufacture according to the embodiments.

Although specific example embodiments have been disclosed, a person skilled in the art will understand that changes can be made to the specific example embodiments without departing from the spirit and scope of the invention.

What is claimed is:

1. A method, comprising:
receiving in a computer, a message from a customer containing preferences for travel services, including willingness to accept alternative travel services, and storing said preferences in a customer database;
receiving in said computer, a message from said customer containing a trip plan that includes at least one segment with a desired mode of transportation, a desired departure location, a desired time, and a desired destination, and storing said trip plan in said customer database;
receiving in said computer, a message from at least one travel service, including available scheduling for said at least one segment, and data for alternative times and modes of transportation, and storing said available scheduling and said data;
receiving in said computer, a message from said customer agreeing to said available scheduling for said at least one segment;
receiving in said computer, a message from said at least one travel service, that said agreed to scheduling for said at least one segment has become unavailable;
accessing said preferences and said data;
determining acceptable alternative times and modes of transportation from said data and said preferences for said at least one segment;
automatically scheduling one of said acceptable alternative times and modes of transportation for said at least one segment; and
sending a notification to said customer of said automatically scheduled alternative time and mode of transportation for said at least one segment.
